(19) United States
(12) Patent Application Publication
(10) Pub. No.: US 2026/0222113 A1
(43) Pub. Date: Jul. 30, 2026

(54) DETECTION OF FAULTS AND DEGRADATIONS IN LARGE TRANSCEIVERS ARRAYS BASED ON ERROR CORRECTION OR DETECTION CODES

(71) Applicant: Telefonaktiebolaget LM Ericsson (publ), Stockholm (SE)

(72) Inventors: Fabio CAVALIERE, Pisa (IT); Stefano STRACCA, Pisa (IT)

(73) Assignee: Telefonaktiebolaget LM Ericsson (publ), Stockholm (SE)

(21) Appl. No.: 19/145,254

(22) PCT Filed: Jan. 19, 2023
(86) PCT No.: PCT/EP2023/051220

§ 371 Date: Jul. 2, 2025

(51) Int. Cl. H04L 1/00

(52) U.S. Cl. CPC H04L 1/0061

(57) ABSTRACT

Embodiments of the invention can relate to a transmitter for parallel transmission of a first plurality of data bits (D), the transmitter comprising a programmable encoder for coding the first plurality of data bits (D) into a second plurality of bits (D+E), wherein the programmable encoder is configured to perform the coding according to a configurable coding algorithm. The transmitter can further comprise parallel transmitter for transmitting the second plurality of bits (D+E) over a plurality of parallel channels, wherein the parallel transmitter is an optical emitting apparatus, and a controller for configuring the configurable coding algorithm. Further embodiments of the invention can relate to a corresponding receiver and transceiver.

### TECHNICAL FIELD

The present invention relates to a transmitter for parallel transmission of a plurality of data bits, a receiver for parallel reception of a plurality of bits, a transceiver or a system, comprising the transmitter and the receiver as well as respective methods.

### BACKGROUND

Transmission of data plays a central role in most electronic devices. Broadly, transmission algorithms can be divided in series and parallel transmissions.

Recently, the transmission of data on a high number, for instance higher than 100, of parallel low bitrate lanes is becoming increasingly popular. Compared to the transmission of serial data on a single high-speed lane, the parallel approach requires lower transmission bandwidth. Parallel transmission techniques make possible the use of Non-Return-to-Zero signals instead of Pulse Amplitude Modulation 4-level, for the modulation format. This, in turn, provides advantages in terms of robustness to noise and power consumption, since neither bit-to-symbol mappers nor FEC are needed. Other advantages of the parallel approach are the reduced and deterministic latency, due to the absence of clock and data recovery, CDR, parallel/serial/parallel converters, wander compensation buffers and FEC.

Parallel transmission on electrical lines is known. Various parallel transmission protocols, such as ISA, ATA, SCSI, PCI and IEEE-488, are known in the art. Most, if not all, of the known protocols have been specifically developed to operate on electrical signals, transmitted on electrical conductors. Due to this, the number of parallel transmission lines has historically been rather low, as each transmission line requires an insulated conductor, an electrical transmitter and receiver, which leads to increase in costs and complexity, for instance due to crosstalk, as the number of transmission line increases.

Recently, parallel transmission based on a plurality of light signals have become more popular. One immediate advantage of using light signals instead of electrical signals is that both the transmitter and the receiver can easily be implemented as 2D arrays, with high level of parallelism, using commercially available devices.

In fact, 2D arrays for transmitting light are known, such as the displays of smartphones, LED TVs, laptops, etc. 2D arrays for receiving light are similarly known. For instance, 2D array of photodetectors are used as sensors for digital cameras, position sensing, optical spectrography, spatially resolved X-rays detectors, etc.

Parallel arrangements of light emitters and receivers are seldom used in telecommunications, where single emitters and detectors, are the norm. Nevertheless, such parallel arrangements achieved a deep level of miniaturization, making both linear and 2D configurations feasible in a small form format. In particular, the aggregate capacity of a 2D array of vertically coupled transmitters increases as the square the side of the photonic integrated circuit, rather than proportionally to it. With parallel data transmission, it is possible to use a single multi-core fiber, packaged with a parallel transceiver, thereby avoiding fiber management issues, for instance in the small space of a PCB.

There is therefore a need to further develop algorithm for parallel transmission of data. Preferably algorithms which are applicable to 2D parallel transmitters.

Although parallel transceivers arrays, for example transceivers arranged in a 2D configuration, are appealing for high-speed short-reach interconnections, they pose new problems in term of reliability. A failure of a single lane can for instance lead to a significant loss of information and Loss of Signal, LOS, alarms on each transceiver can not be implemented for cost saving, power consumption or footprint issues.

To make the system more resilient, it is necessary to develop algorithms and devices which allow for detection and/or correction of errors in those systems.

A trivial way to improve the system resiliency is sending the same information bit to two different transceivers so that if one of them fails, the other one can replace it, a technique known as 1+1 protection. However, this technique duplicates number of transceivers and total cost and it anyways requires a protocol to detect faulty links.

Another example of 2D error correction code consists of data arranged in a square matrix, with a row and a column added for parity check bits. Wrong parity checks in the i-th element of the additional row and the j-th element of the additional column indicate an error in the (i, j) element of the data matrix, making it possible to correct it. This concept is further extended by block codes, a wide family of error correction codes that generate a n-bit codeword starting from a k-bit sequence of data, with n>k. A block code is a systematic code if the first k bits in the codeword are the original data and the remaining n-k are parity check bits. The codeword can be either transmitted as a serial sequence of data, on a single lane, or sent altogether over parallel lanes.

Those algorithms are nevertheless not considered efficient enough for practical implementations.

### SUMMARY

There is therefore a need to provide more efficient mechanisms and/or devices for the parallel transmission of data, preferably for the transmission of data based on two-dimensional, 2D, arrays of optical transmitters and receivers.

This need may be met by the features of the independent claims. Further aspects are described in the dependent claims.

An embodiment of the invention can relate to a transmitter for parallel transmission of a first plurality of data bits. The transmitter can comprise a programmable encoder for coding the first plurality of data bits into a second plurality of bits, wherein the programmable encoder can be configured to perform the coding according to a configurable coding algorithm. The transmitter can further comprise parallel transmitter for transmitting the second plurality of bits over a plurality of parallel channels, wherein the parallel transmitter is an optical emitting apparatus.

The transmitter can further comprise a controller for configuring the configurable coding algorithm.

In some embodiments, the parallel transmitter can be implemented as a two-dimensional array.

In some embodiments, the parallel transmitter can be implemented as a plane and/or can be configured to emit light substantially perpendicularly with respect to the plane.

In some embodiments, the controller can be configured to receive controlling data from a receiver, which can be connected to the transmitter. Moreover, the controller can be configured to configure the configurable coding algorithm based on the controlling data.

In some embodiments, the second plurality of bits can comprise the first plurality of data bits and a third plurality of error detecting and/or correcting bits. The programmable encoder can be configured to generate the third plurality of error detecting and/or correcting bits based on the first plurality of data bits and the configurable coding algorithm.

In some embodiments, the second plurality of bits can comprise the first plurality of data bits and a third plurality of error detecting and/or correcting bits. The programmable encoder can be configured to
associate the first plurality of data bits to the second plurality of bits, and/or
associate the third plurality of error detecting and/or correcting bits to the second plurality of bits, based on the configurable coding algorithm.

In some embodiments, the second plurality of bits can comprise the first plurality of data bits and a third plurality of error detecting and/or correcting bits. The programmable encoder can comprise switcher, which can be configured to
associate the first plurality of data bits to the second plurality of bits, and/or
associate the third plurality of error detecting and/or correcting bits to the second plurality of bits,

based on the configurable coding algorithm.

In some embodiments, the programmable encoder can further comprise encoder. The encoder can be configured to generate the third plurality of error detecting and/or correcting bits based on the first plurality of data bits and a first coding algorithm.

In some embodiments, the first coding algorithm can be the configurable coding algorithm.

A further embodiment of the invention can relate to a receiver for parallel reception of a second plurality of bits. The receiver can comprise a programmable decoder for decoding the second plurality of bits into a first plurality of data bits, wherein the programmable decoder can be configured to perform the decoding according to a configurable coding algorithm. The receiver can further comprise parallel receiver for receiving the second plurality of bits over a plurality of parallel channels, wherein the parallel receiver can be an optical capturing apparatus. The receiver can additionally comprise a controller for configuring the configurable coding algorithm.

In some embodiments, the parallel receiver can be implemented as a two-dimensional array. In some embodiments, the parallel receiver can be implemented as a plane and can be configured to capture light substantially perpendicularly with respect to the plane.

In some embodiments, the controller can be configured to compute controlling data based on errors identified in the reception, the controller can be configured to configure the configurable coding algorithm based on the controlling data.

In some embodiments, the second plurality of bits can comprise the first plurality of data bits and a third plurality of error detecting and/or correcting bits, and the programmable decoder can be configured to generate the first plurality of data bits based on the third plurality of error detecting and/or correcting bits and the configurable coding algorithm.

In some embodiments, the second plurality of bits can comprise the first plurality of data bits and a third plurality of error detecting and/or correcting bits. The programmable decoder can be configured to
associate the second plurality of bits to the first plurality of data bits, and/or
associate the second plurality of bits to the third plurality of error detecting and/or correcting bits, based on the configurable coding algorithm.

In some embodiments, the second plurality of bits can comprise the first plurality of data bits and a third plurality of error detecting and/or correcting bits. The programmable decoder can comprise switcher, which can be configured to
associate the second plurality of bits to the first plurality of data bits, and/or
associate the second plurality of bits to the third plurality of error detecting and/or correcting bits,

based on the configurable coding algorithm.

In some embodiments, the programmable decoder further can comprise decoder, which can be configured to generate the first plurality of data bits based on the third plurality of error detecting and/or correcting bits and the first coding algorithm.

In some embodiments, the first coding algorithm can be the configurable coding algorithm.

In some embodiments, the second plurality of bits can comprise the first plurality of data bits and a third plurality of error detecting and/or correcting bits. The plurality of parallel channels can comprise a plurality of logical rows and a plurality of logical columns, where
a first one of the first plurality of data bits can be mapped to a first data channel, the first channel corresponding to a first logical row and a first logical column,
a first one of the third plurality of error detecting and/or correcting bits can be mapped to a first error channel, the first error channel corresponding to the first logical row, and
a second one of the third plurality of error detecting and/or correcting bits can be mapped to a second error channel, the second error channel corresponding to the first logical column.

In some embodiments, the controller can be configured to evaluate if a first row error can be detected at the first logical row. If the first row error has been detected, the controller can be configured to evaluate if a first column error can be detected at the first logical column. If the first column error can be detected, the controller can be configured to determine that a first error has been detected at the first data channel. If it is determined that the first error has been detected, the controller can configured to evaluate if the first error has been detected within a first predetermined time, and, if the first error has been detected within the first predetermined time, determine that the first data channel is degraded.

In some embodiments, the controller can be further configured to evaluate if a second row error can be detected at the first logical row, and, if the second row error has been detected, evaluate if a second column error can be detected at the first logical column. If the second column error can be detected, the controller can be configured to determine that a second error has been detected at the first data channel, and, if it is determined that the second error has been detected, the controller can be configured to evaluate if the second error has been detected within a second predetermined time. If the second error has been detected within the second predetermined time, the controller can be configured to determine that the first data channel is degraded.

In some embodiments, given the equation

$$N = f ( \frac{1}{BER} ) * [ g ( CL ) + h ( {\sum }_{k = 0}^{E} ( N * BER ) ) ]$$

where
N can be a number of transmitted first plurality of data bits,
BER can be a bit error rate, set to a predetermined value indicative of a degraded data channel,
E can be a number of measured errors,
CL can be confidence level, set to a predetermined value,
f, g and h are monotone non-decreasing functions,

the first predetermined time can be computed as a time for which the equation can be solved for the number of measured errors equal to 0, and the second predetermined time can be computed as a time for which the equation can be solved for the number of measured errors equal to 1.

In some embodiments the equation can be expressed as

$$N = \frac{1}{BER} [ - ln ( 1 - CL ) + ln {\sum }_{k = 0}^{E} ( \frac{{( N * BER )}^{k}}{k !} ) ]$$

In some embodiments, the controller can be configured to evaluate if the first data channel is degraded based on the third plurality of error detecting and/or correcting bits. If it is determined that the first data channel is degraded, the controller can be configured to configure the configurable coding algorithm so as to substitute the first error channel, or the second error channel, with the first data channel.

In some embodiments, the second plurality of bits can comprise the first plurality of data bits and a third plurality of error detecting and/or correcting bits, and the controller can be configured to evaluate if the first data channel is degraded based on the third plurality of error detecting and/or correcting bits. If it is determined that the first data channel is degraded, the controller can be configured to configure the configurable coding algorithm so as to turn off the first data channel.

In some embodiments, the second plurality of bits can comprise the first plurality of data bits and a third plurality of error detecting and/or correcting bits and the controller can be configured to evaluate if the first data channel is degraded based on the third plurality of error detecting and/or correcting bits. If it is determined that the first data channel is degraded, configure the configurable coding algorithm so as to assign lower priority traffic the first data channel.

In some embodiments, the second plurality of bits can comprise the first plurality of data bits and a third plurality of error detecting and/or correcting bits and the controller can be configured to evaluate if the first data channel is degraded based on the third plurality of error detecting and/or correcting bits. If it is determined that the first data channel is degraded, the controller can be configured to partition the plurality of parallel channels into a first partition, comprising the first data channel, and a second partition, comprising the first data channel. Moreover, if it is determined that the first data channel is degraded, the controller can be configured to configure the configurable coding algorithm so as to implement different coding algorithms in the first and second partitions.

In some embodiments, if it is determined that the first data channel is degraded, the controller can be further configured to configure the configurable coding algorithm so as to implement a lower transmission bit rate in the first partition.

In some embodiments, for evaluating if the first data channel is degraded the controller can be further configured to determine, based on the third plurality of error detecting and/or correcting bits, if the first data channel experiences an error rate higher than a predetermined threshold.

In some embodiments, the controller can be further configured to determine, based on the third plurality of error detecting and/or correcting bits, if the first data channel experiences the error rate higher than the predetermined threshold within a predetermined time.

A further embodiment of the invention can relate to a transceiver, comprising the transmitter according to any of the embodiments above and a receiver according to any of the embodiments above.

A further embodiment of the invention can relate to a communication system comprising the transmitter according to any of the embodiments above and a receiver according to any of the embodiments above, connected by a communication channel.

A further embodiment of the invention can relate to a telecommunications network node comprising the transmitter according to any of the embodiments above, and/or the receiver according to any of the embodiments above, and/or the transceiver according to any of the embodiments above.

A further embodiment of the invention can relate to a transmitting method for parallel transmission of a first plurality of data bits. The method can comprise a step of configuring a configurable coding algorithm, and a step of coding the first plurality of data bits into a second plurality of bits according to the configurable coding algorithm. Additionally, the method can comprise a step of optically transmitting the second plurality of bits in parallel, over a plurality of parallel channels. Moreover, further embodiments can be obtained by further including any of the previously described steps in the transmitting method.

A further embodiment of the invention can relate to a receiving method for parallel reception of a second plurality of bits. The method can comprise a step of configuring a configurable coding algorithm, and a step of optically receiving the second plurality of bits in parallel over a plurality of parallel channels. Additionally, the method can comprise a step of decoding the second plurality of bits into a first plurality of data bits according to the configurable coding algorithm. Moreover, further embodiments can be obtained by further including any of the previously described steps in the receiving method.

### BRIEF DESCRIPTION OF DRAWINGS

Various features of embodiments will become more apparent when read in conjunction with the accompanying drawings. In these drawings:

FIG. 1A schematically illustrates a communication system 100;

FIG. 1B schematically illustrates a transmitter 110;

FIG. 1C schematically illustrates a receiver 120;

FIG. 1D schematically illustrates a transceiver 130;

FIG. 1E schematically illustrates a controlling channel 140;

FIG. 1F schematically illustrates a data channel 150;

FIG. 2 schematically illustrates a programmable encoder 212;

FIG. 3 schematically illustrates a programmable decoder 322;

FIGS. 4 to 6 schematically illustrate steps of methods 400, 500, 600 for configuring the coding algorithm;

FIG. 7A schematically illustrates a logical representation of a two-dimensional array of channels 750A;

FIG. 7B schematically illustrates a possible mapping 750B to the dimensional array of channels 750A;

FIG. 7C schematically illustrates mapping 750C, where an error is present at data channel D 3, 4;

FIG. 7D schematically illustrates steps of method 700 for determining if a channel is degraded;

FIGS. 7E and 7F schematically illustrate mapping 750E and 750F to the dimensional array of channels 750A, where an error is further present at data bit D 3, 3 and D 2, 3, respectively, compared with mapping 750C;

FIG. 8A schematically illustrates steps of method 800 for configuring the coding algorithm;

FIG. 8B schematically illustrates a possible mapping 850B resulting from the application of method 800 to the mapping 750C;

FIG. 9 schematically illustrates curves for the determination of a first predetermined time T0 and of a second predetermined time T1;

FIG. 10 schematically illustrates steps of method 1000 for transmitting a plurality of data bits;

FIG. 11 schematically illustrates steps of method 1100 for receiving a plurality of data bits.

### DETAILED DESCRIPTION

Some examples of the present disclosure generally provide for a plurality of circuits, electrical devices, or more in general apparatuses which can be implemented as electrical devices. For instance, in various embodiments, reference will be made to transmitter 110, controller 111, programmable encoder 112, parallel transmitter 113, receiver 120, controller 121, programmable encoder 122, parallel receiver 123, transceiver 130, controller 131, controlling channel 140, 150: data channel, programmable encoder 212, encoder 2121, switcher 2122, programmable decoder 322, decoder 3221 and switcher 3222.

All references to the various apparatuses and the functionality provided by each are not intended to be limited to encompassing only what is illustrated and described herein. While particular labels may be assigned to the various apparatuses disclosed, such labels are not intended to limit the scope of operation for the apparatuses. Such apparatuses may be combined with each other and/or separated in any manner based on the particular type of implementation that is desired.

It is recognized that any apparatus disclosed herein may include any number of microcontrollers, integrated circuits, CPUs, memory devices (e.g., FLASH, random access memory (RAM), read only memory (ROM), electrically programmable read only memory (EPROM), electrically erasable programmable read only memory (EEPROM), or other suitable variants thereof). Moreover, those skilled in the art will appreciate that any apparatus disclosed herein may include software which co-act with one another to perform operation(s) disclosed herein. In addition, any one or more of the apparatuses may be configured to execute a program code that is embodied in a non-transitory computer readable medium programmed to perform any number of the functions, or method steps, as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

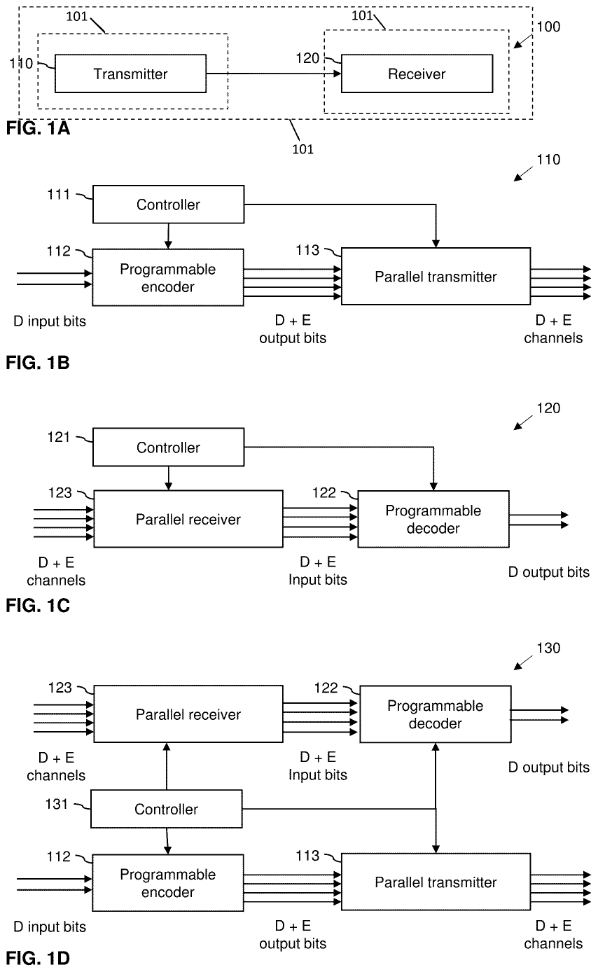

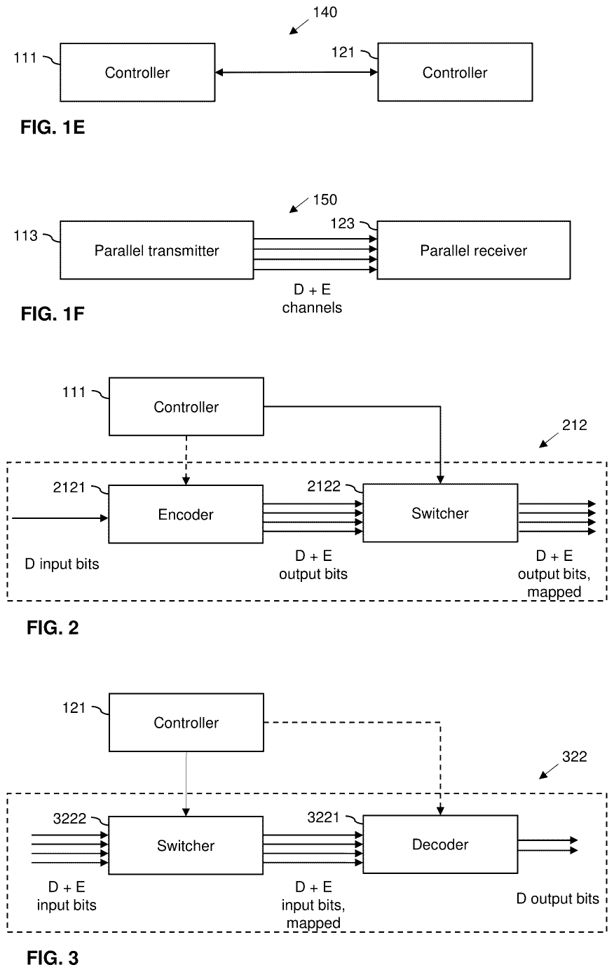

FIG. 1A schematically illustrates a communication system 100 comprising a transmitter 110, illustrated more in details in FIG. 1B, and a receiver 120, illustrated more in details in FIG. 1C. In the following description, operation of the transmitter 110 and of the receiver 120 will be described independently of each other. It will however be clear that, in some implementations, both a transmitter 110 and a receiver 120 can be implemented together in a transceiver 130 as illustrated for instance in FIG. 1D. It will moreover be clear that the transmitter 110 and the receiver 120 can be implemented together as communication system 100 when connected to each other by an appropriate communication channel. In preferred embodiments the communication channel is an optical link, such as a light guide, for instance fiber optic light guides. Even more preferably, the communication channel can be an optical link allowing for a plurality of physical channels to be implemented in parallel. Such channels are known in the art for instance as parallel optical interfaces and can be implemented, for instance, through a plurality of optical fibers, and/or through a plurality of channels in a single optical fiber, for instance by using a multi-mode optical fiber and associating different channels to different modes.

The communications system 100 may be a telecommunications system and, in some embodiments, each of the transmitter 110 and receiver 120 may be part of a respective telecommunications network node 101. For example, the telecommunications system may comprise a connection between a baseband processor and a Radio Frequency Integrated Circuit (RFIC) located in a radio system. Alternatively, the transmitter 110 and receiver 120 may be part of the same telecommunications network node 101 as illustrated by the outer dashed lines in FIG. 1a. For example, the communications system 100 may comprise an interface between MAC (Medium Access Control) and PCS/PMA (Physical Coding Sublayer/Physical Medium Attachment) in a switch or NIC (Network Interface Card), based on xMII (x bit rate Medium Independent Interface) or similar protocols. Alternatively, the communications system may comprise a connection between processors and storage units in a data center for example.

In general, the transmitter 110 is configured to transmit a plurality of data to the receiver 120, encoded logically as bits. The skilled person will know various manners for the physical encoding of such logical bits and those will not be discussed in details in the invention, any known manner being possible to be implemented. Similarly, the receiver 120 is generally configured to receive the data from the transmitter 110.

In particular, as visible in FIG. 1B, the transmitter 110 is configured to transmit a plurality of bits over a plurality of D+E channel, preferably in parallel. It is understood that each of the D+E channels can transmit more than one bit, in series. The bits transmitted on the D+E channels are derived from a plurality of D input bits in a manner which will be described more in details in the following.

Similarly, as visible in FIG. 1C, the receiver 120 is configured to receive the plurality of bits over a corresponding plurality of D+E channel, again preferably in parallel. The bits received on the D+E channels can then be used to derive a plurality of D output bits in a manner which will be described more in details in the following.

In the following, the transmitter 110 will be discussed first.

As discussed, the transmitter 110 can generally be configured for parallel transmission of a plurality of input bit, or data bits, D. In order to do so, the transmitter 110 comprises a programmable encoder 112 for coding the plurality of data bits D into a plurality of bits D+E, and parallel transmitter 113 for transmitting the plurality of bits D+E over the plurality D+E of parallel channels 150.

In general, the programmable encoder 112 may encode, or map, the data bits D into a plurality of bits D+E, which is larger than D, to include error correction or detection bits E. In the following, the error correction or detection bits E can also be referred to as error bits E, it will be clear that this is not meant to indicate that the bits E are erroneous. The general purpose of correction or detection bits E is to allow the detection and/or correction of errors on the data bits D at the receiver 120. It will be clear to those skilled in the art that a plurality of algorithms, per se known, can be implemented for generating the error correction or detection bits E based on the data bits B.

One particularly advantageous feature of the invention, as will become clear from the following description, is that the coding performed by the programmable encoder 112 can be changed, according to a configurable coding algorithm. That is, the manner in which the error bits E are generated on the basis of the data bits D, and/or the mapping of the input bits D and/or of the error bits E to the channels D+E, is not necessarily fixed and can be advantageously changed based on controlling information, preferably provided by the receiver 120, as will be discussed more in details in the following.

Having a configurable coding algorithm that is not fixed allows the configuration of the transmitter to be changed during its operation. For instance, as will result clearer from the description of some more specific embodiments in the following, channels which are deemed to be degraded can be turned off, or switched with other channels, and the ability to reconfigure the coding algorithm can allow for the transmission to continue with the new channel configuration. More generally, the ability to configure the coding algorithm during the operation of the transmitter allows the transmitter 110 to adapt to various changes and/or failures in the physical transmission line, including any of the parallel transmitter 113, the corresponding parallel receiver 123, and the channels between them, which will be described more in details in the following.

The transmitter further comprises a controller 111 for configuring the configurable coding algorithm of the programmable encoder 112. Preferably, as will become clearer from the following description, the controller 111 can configure the configurable coding algorithm of the programmable encoder 112 based on information received through a controlling channel 140, schematically illustrated for instance in FIG. 1E, which connects the controller 111 of the transmitter with the controller 121 of the receiver 120.

In the transmitter 110, the parallel transmitter 113 is an optical emitting apparatus. It is relatively easy to implement a plurality of optical emitting apparatuses in parallel, for instance by a plurality of light emitting diodes (LED or lasers), from a single silicon chip, thus reducing manufacturing costs and achieving very high parallelization.

In preferred embodiments, the parallel transmitter 113 can be implemented as a two-dimensional array. In further preferred embodiments, the parallel transmitter 113 is implemented as a plane and/or is configured to emit light substantially perpendicularly with respect to the plane. Those features allows a more dense packing of the parallel transmitter 113, in addition to making a more efficient usage of silicon surface. Various commercial devices are further available with this configuration so that the invention can be easily implemented with off the shelf components. Furthermore, the two-dimensional array can simplify connection to one or more optical transmission channel(s).

Turning back to the operation of the configurable coding algorithm, as previously indicated, the controller 111 can generally be configured to receive controlling data from the receiver 120, which can be connected to the transmitter 110, and the controller 111 can be configured to configure the configurable coding algorithm based on the controlling data.

In particular, as will become clearer from the following description, the controlling data can be based on error detection performed at the receiver 120. Even more specifically, the detection of errors thresholds, and more in particular the detection of bit error rate thresholds, can be performed at the receiver 120. Once those thresholds are reached or surpassed, the configurable algorithm can be adapted in various manners.

It will be clear that measurement of said thresholds and/or the configuration of the configurable algorithm can be equally performed at the receiver 120 or at the transmitter 110. For instance, both the measurement and configuration can take place at the receiver 120 and the newly configured algorithm can be sent to the transmitter 110, for instance through channel 140. Alternatively, the measurement can be performed at the receiver 120, and the measured values can be sent to the transmitter 110, which can then execute the configuration of the new algorithm based thereon. Still alternatively, or in addition, the raw error data can be sent from the receiver 120 to the transmitter 110, which can then execute the measurement and the configuration.

In the following, various examples will be described in which one of those embodiments is implemented, for instance where the measurement and configuration are executed at the receiver 120. It will however be clear to those skilled in the art that the embodiments can be changed accordingly, for instance by executing the measurement at the receiver 120 and the configuration at the transmitter 110, in a manner which will be clear to those skilled in the art.

As previously discussed, the plurality of bits D+E comprises the plurality of data bits D and a plurality of error detecting and/or correcting bits E. The programmable encoder 112 can be in particular configured to generate the plurality of error detecting and/or correcting bits E based on the plurality of data bits D and the configurable coding algorithm.

Various manners are known to those skilled in the art for generating error bits E based on data bits D. For instance, parity check bits can be used as error bits E for a given number of data bits D.

Moreover, as previously discussed, the programmable encoder 112 can be configured to associate the plurality of data bits D to the plurality of bits D+E, and/or associate the plurality of error detecting and/or correcting bits E to the plurality of bits D+E, based on the configurable coding algorithm.

That is, a given bit can be associated to a given position of the data bits D, for instance position X, and it can be mapped to any position of the bits D+E. For instance, assuming the bits D and D+E are logically organized as a vector, a bit at position 2 in the vector D can be association to another position, for instance 4, in the vector D+E. As an alternative example, assuming the bits D and D+E are logically organized as a matrix, a bit at position 1,2 in the matrix D can be association to another position, for instance 1,4, in the matrix D+E.

The skilled person will be aware of various manners for performing such mapping, which might depend on various factors such as the coding algorithm used for generating the error bits E, the avoidance of cross-channel crosstalk, and others. In general, the mapping, or association, is configured by the configurable algorithm and, as will be discussed more in details in the following, it can be changed as the configurable algorithm is changed.

Both the generation of the error bits E and the mapping of the data and error bits D e E to the bits D+E can be performed by the programmable encoder 112, as schematically illustrated in FIG. 1B, where the programmable encoder 112 takes as input the bits D and generates the mapped bits D+E. In this case, the controller 111 can control both operations of the programmable encoder 112, namely the generation of the error bits E and the mapping, independently, based on the programmable algorithm.

Alternatively, as illustrated in FIG. 2, a programmable encoder 212, which can be seen as a more specific implementation of the programmable encoder 112 and, can comprise encoder 2121 and switcher 2122. Generally, the encoder 2121 can perform the generation of the error bits E, while the switcher 2122 can perform the mapping function. It will be clear to those skilled in the art that those operations can be independently controlled by the controller 111.

More in particular, the switcher 2122 can be configured to associate the plurality of data bits D to the plurality of bits D+E, and/or associate the plurality of error detecting and/or correcting bits E to the plurality of bits D+E based on the configurable coding algorithm, as previously described.

The encoder 2121 can be similarly configured to generate the plurality of error detecting and/or correcting bits E based on the plurality of data bits D and a first coding algorithm. In some embodiments, the first coding algorithm used for the generation of the error bits E can be an algorithm which is different from the configurable coding algorithm, and can be predetermined. That is, the configurable coding algorithm can be used to configure the mapping function through the switcher 2122 but not the error coding function through the encoder 2121, which can instead be based on a different, possibly predetermined, algorithm. In this case, the predetermined algorithm might also be available at the encoder 2121 without connection to the controller 111, as indicated by the dashed line connecting the encoder 2121 and the controller 111, which can therefore be optional. Alternatively, the first coding algorithm used for the generation of the error bits E can be the configurable coding algorithm. In this case the controller can communicate the configurable coding algorithm to both the switcher 2122 and the encoder 2121.

In the description above, various features have been described with reference to the transmitter 110. In the following, analogous features will be described for the receiver 120. It will be clear to those skilled in the art that considerations made for the transmitter 110 can be applied to analogous features for the receiver 120, and vice versa.

Moreover, as previously indicated, it will be clear that a transceiver 130, as schematically illustrated in FIG. 1D, can be realized to implement the functionality of both the transmitter 110 and the receiver 120. In this case, a controller 131 can be realized to implement all characteristics which are described for the controller 111 of transmitter 110 and for the controller 121 of the receiver 120.

As schematically illustrated in FIG. 1C, receiver 120 can general be configured for parallel reception of a plurality of bits D+E and can comprise parallel receiver 123, for receiving the plurality of bits D+E over a plurality of parallel channels 150, and a programmable decoder 122 for decoding the plurality of bits D+E into a plurality of data bits D.

Generally, the operation of the programmable decoder 122 is the inverse of the programmable encoder 112, while the operation of the parallel receiver 123 is the inverse of the parallel transmitter 113, so that the considerations previously made for the programmable encoder and for the parallel transmitter 113 can be applied, mutatis mutandis, to the programmable decoder 122 and to the parallel receiver 123.

In particular, the parallel receiver 123 is an optical capturing apparatus and the programmable decoder 122 is configured to perform the decoding according to a configurable coding algorithm. The configurable coding algorithm, in the description, is understood to define the coding and decoding characteristics of the algorithm, so that it can be used at both the transmitter 110 and the receiver 120. It will nevertheless be clear that those characteristics can also be divided into coding characteristics and decoding characteristics, and that the coding characteristic can be provided to the transmitter 110 while the decoding characteristics can be provided to the receiver 120. For the sake of simplicity, in the description reference is generally made to the configurable coding algorithm as comprising the necessary characteristics for the unit at which it is employed.

In some embodiments, the parallel receiver 123 can be implemented as a two-dimensional array and can be implemented as a plane. Moreover, the parallel receiver 123 can be configured to capture light substantially perpendicularly with respect to the plane. As in the case of the parallel transmitter 113, this enables the use of densely packed transceivers.

As for the transmitter 110, the receiver 120 comprises a controller 121 for configuring the configurable coding algorithm. It will be clear to those skilled in the art that, in general, the configuration of the configurable coding algorithm can be executed only once, at either the transmitter 110 or the receiver 120, and then transmitted to the other unit, once the new algorithm has been configured, so as to avoid repeating the configuration at the two units, or a divergence in the configuration of the algorithm between the two units. In the description above, it has been discussed how the configuration can be implemented at the transmitter 110, based on data received from the receiver 120, and how the configuration affects the operation of the transmitter 110. In the following description it will be described how the configuration affects the operation of the receiver 120. Still further, it will be described how the receiver 120 can measure errors and how the configuration of the algorithm can be executed on the basis of this measurement. Moreover, specific examples will be provided on how the algorithm can be modified.

In general, the controller 121 can be configured to compute controlling data based on errors identified in the reception and to configure the configurable coding algorithm based on the controlling data.

More specifically, the plurality of bits D+E comprises the plurality of data bits D and the plurality of error detecting and/or correcting bits E, as previously described, and the programmable decoder 122 can be configured to generate the plurality of data bits D based on the plurality of error detecting and/or correcting bits E and the configurable coding algorithm.

Analogously as what indicated before for the transmitter 110, the decoding operation can generally comprise a mapping functionality, for identifying which bits are data bits D and which are error bits E, as well for identifying which error bits E apply to which data bits D, and a decoding functionality. The skilled person is aware of various decoding algorithms for the decoding functionality, which allow output data bits D to be generated on the basis of the data and error bits D+E. For instance, in cases where the error bits E allow correction of errors, the skilled person is aware how the data bits D can be generated by correcting errors present in the D+E bits. That it, it will be obvious that the D bits in the D+E combination do not necessarily correspond to the output D bits after application of the algorithm.

More specifically, the programmable decoder 122 can be is configured to associate the plurality of bits D+E to the plurality of data bits D, and/or associate the plurality of bits D+E to the plurality of error detecting and/or correcting bits E, based on the configurable coding algorithm. That is, the recognition of which of the bits D+E are to be mapped to which of the data bits D and to which of the error bits E can be performed on the basis of the configurable coding algorithm. Reference is made to the previous examples of mapping based on addresses of a logical vector or of a logical matrix.

As previously indicated the programmable encoder 212 can be a specific implementation of the programmable encoder 112, in which the coding and mapping functions are performed independently. Similarly, programmable decoder 122 can be implemented as programmable decoder 322, schematically illustrated in FIG. 3. In particular, programmable decoder 322 comprises switcher 3222 and decoder 3221, which generally operate the opposite functions of switcher 2122 and of encoder 2121.

In particular, the switcher 3222 can be configured to associate the plurality of bits D+E to the plurality of data bits D, and/or associate the plurality of bits D+E to the plurality of error detecting and/or correcting bits E, based on the configurable coding algorithm. Moreover, the decoder 3221 can be configured to generate the plurality of data bits D based on the plurality of error detecting and/or correcting bits E and the first coding algorithm. The considerations previously made for the first coding algorithm and the configurable coding algorithm also apply to the programmable decoder 322.

In the description above it has been generally indicated that the configurable algorithm can be configured to take into account errors detected at the receiver 120. The skilled person will be aware that the detection of errors can take various forms, depending on the specific coding algorithm. In the following description examples will be presented for how errors can be detected according to particularly advantageous embodiments of the invention.

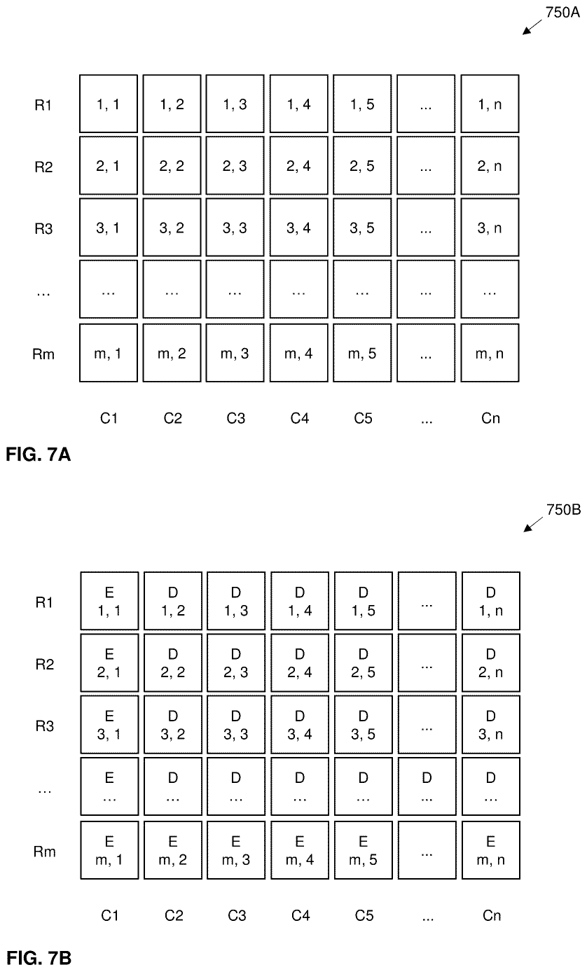

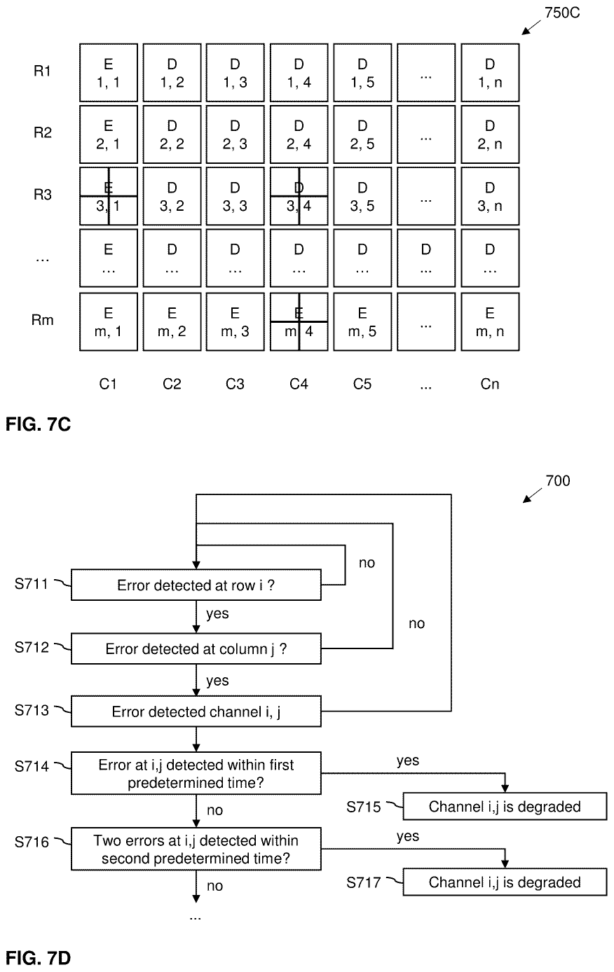

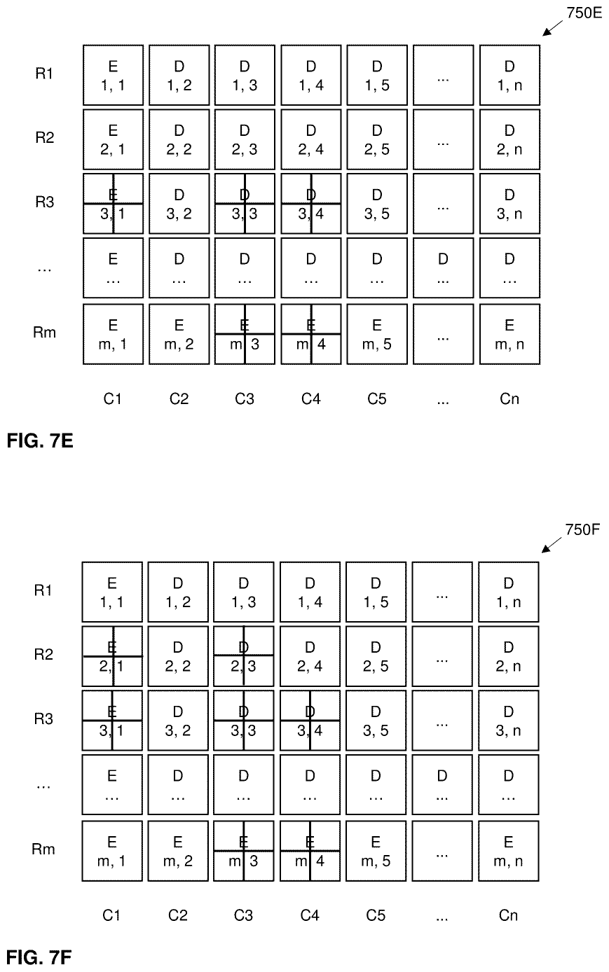

FIG. 7A schematically illustrates a logical representation of a two-dimensional array of channels 750A. The channels 750A logically corresponds to a possible logical arrangement of the plurality of channels 150. That is, it is understood that the plurality of channels 150 does not need to by physically arranged in the illustrated manner, but rather that each of the channels 150 is logically associated to a position in the two-dimensional array of channels 750A.

The two-dimensional array of channels 750A can be through of a matrix with a plurality of logical rows R1-Rm and a plurality of logical columns C1-Cn, such that each of the channels, and thus each of the D+E bits, can be associated to a given address R,C or the matrix.

FIG. 7B schematically illustrates a possible mapping 750B to the dimensional array of channels 750A. It will be understood that this is only one of various possible mappings and is not intended to limit the invention. Moreover, it will be clear than analogous operations can be achieved by mere transposition of the mapped bits.

In the example of FIG. 7B, the first column C1 and the last row Rm of the channels are mapped to error bits E, while the rest of the channels are mapped to data bits D. Moreover, in the illustrated example, error bits E are considered to be parity bits, computed for the respective row or column. Thus, for instance, error bit E 1,1 is a parity bit for the data bits D in row R1, while error bit E 2,1 is a parity bit for the data bits D in row R2. Similarly, error bit E m,2 is a parity bit for the data bits D in column C2, while error bit E m,3 is a parity bit for the data bits D in column C3. It will be clear to those skilled in the art that other types of error coding can be employed and the invention is not limited to parity check.

With the illustrated mapping, a first one of the plurality of data bits D can be mapped to a first data channel D. In the following example this will be considered to be the channel at address 3,4, namely to a first logical row R3 and a first logical column C4.

Additionally, a first one of the plurality of error detecting and/or correcting bits E can be mapped to a first error channel E. For the purposes of this example, the first error channel E will be considered to be the channel at address 3,1, namely corresponding to the parity bit associated to the first logical row R3. Similarly, a second one of the plurality of error detecting and/or correcting bits E can be mapped to a second error channel E m,4. For the purposes of this example, the second error channel will be considered as the channel at address E m,4, corresponding to the parity bit associated to the first logical column C4.

FIG. 7C schematically illustrates mapping 750C, where an error is present at data channel D 3, 4. In this case, as illustrated, the error bits E at addresses 3,1 and m,4 will indicate the presence of an error. Those exemplary conditions will be used to indicate how the coding algorithm can detect the presence of an error and, more generally, how the invention can detect if one or more channels is degraded, depending on the detection of one or more errors. Subsequently, it will be described what kind of countermeasures can be taken if it is evaluated that a channel is degraded.

FIG. 7D schematically illustrates steps of method 700 for determining if a channel is degraded. In particular, the method 700 can be executed by controller 121 or 131, if executed at the receiver. It will however be clear that method 700 can be analogously executed at the transmitter 110.

Method 700 comprises a step S711 to evaluate if a first row error is detected at the first logical row, in the example of FIG. 7C this being row R3. If no error is detected, the method starts again from the beginning. In the illustrated example, an error is detected and the method moves on to step S712.

At step S712 it is evaluated if a first column error is detected at the first logical column, in the example of FIG. 7C this being column C4. Also in this case, if no error is detected, the method starts again from the beginning. In the illustrated example, an error is detected and the method moves on to step S713. It will be clear that steps S711 and S712 can be exchanged with each other.

At step S713 it is determined that a first error has been detected at the first data channel D 3,4, since both the error bits for row R3 and column C4 indicate the presence of an error. This advantageously allows a double check on the presence of an error at the first data channel D 3,4, so that an error on only one of the error bits E does not lead to the erroneous detection. It will however be clear that, in some embodiments, it might be sufficient to obtain a positive outcome of step S711 or of step S712 to proceed to step S713.

Moreover, it is clear that various other checks can be executed to arrive at the conclusion, at step S713, that an error is present at a given data channel. Those checks depend on the type of error bits E and how they are mapped to the data bits D and will be clear to those skilled in the art once the coding algorithm and the mapping is defined.

Independently on how step S713 is reached, with the execution of step S713 it is determined that a first error has been detected.

Errors can occur for a variety of reasons, which can be permanent or not. For instance, temporary noise on the transmission channel can lead to a temporary presence of a single error on a transmission, while a structural failure on the transmission channel can lead to a permanent presence of errors on it. Various conditions can lead to a plurality of cases between those two extremes.

The invention advantageously allows to determine if a channel is degraded or not. Once a channel is identified as being degraded, it might be possible to take actions which are different from the simple retransmission, or correction of the error on the channel, if possible. Those actions will be discussed more in details in the following, attention will be first given to the determination of whether the channel is degraded or not.

To this effect, method 700 comprises a step S714, at which it is evaluated if the first error has been detected within a first predetermined time T0, and a step S715 at which it is determined that the first data channel, in the illustrated example channel D 3,4, is degraded, if the first error has been detected within the first predetermined time T0.

Measurement of the presence of at least one error, or, as will be described, at least a predetermined number of errors within a predetermined time can be understood to be equivalent to a measurement of an error bit rate. Thus, in some embodiments of the invention, a channel can be considered to be degraded if a predetermined bit error rate on the channel is deemed to have been reached.

Thus, in some embodiments, for evaluating if the first data channel D 3,4 is degraded the controller is further configured to determine, based on the plurality of error detecting and/or correcting bits E, if the first data channel D 3,4 experiences an error rate higher than a predetermined threshold. Even more specifically, the controller is further configured to determine, based on the plurality of error detecting and/or correcting bits E, if the first data channel D 3,4 experiences the error rate higher than the predetermined threshold within a predetermined time.

How the predetermined time for the determination of the bit error rate is computed will be clear to those skilled in the art. Generally, a bit error rate is defined as the ratio of erroneous transmissions on a given channel over a predetermined unit of time.

In the following, particularly advantageous embodiments will be described which allow the computation of a predetermined time which is sufficient for rapidly and reliably determining if the bit error rate threshold has been reached. This advantageously allows the predetermined time to be short, so that the determination of the degradation on a given channel can be executed rapidly, which is advantageous since it allows a rapid implementation of countermeasures as well as a reduced use of computational resources.

The following equation

$$N = f ( \frac{1}{BER} ) * [ g ( CL ) + h ( {\sum }_{k = 0}^{E} ( N * BER ) ) ]$$

where
N is a number of transmitted plurality of data bits D,
BER is a bit error rate, set to a predetermined value indicative of a degraded data channel,
E is a number of measured errors,
CL is confidence level, set to a predetermined value,
f, g and h are monotone non-decreasing functions,

correlates the bit error rate with the number of measured errors and the number of transmitted data bits E. The bit error rate can be defined as the number of measured error over a predetermined unit of time. The equation can be implemented in various forms, as will be clear to those skilled in the art, by an appropriate selection of the functions f, g, and h. One possible, and non limiting, implementation is

$$N = \frac{1}{BER} [ - ln ( 1 - CL ) + ln {\sum }_{k = 0}^{E} \frac{N * {BER}^{k}}{k !} ]$$

By solving numerically the equation for each integer value of E it is possible to calculate (N*BER) as a function of CL. A predetermined value of BER can be selected as threshold, N can be computed by the ratio of observation time T_{OBS} and the bit time, T_{B}, both of which are known.

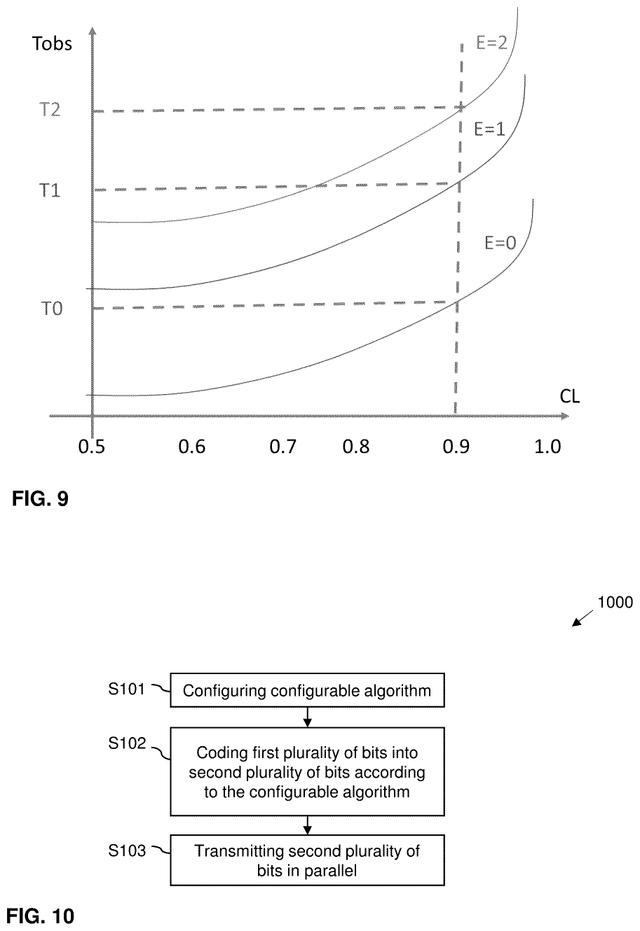

In order to visualize how the equation can be solved, in the following a description will be given based on FIG. 9, in which family of curves is plotted for T_{OBS} vs. CL. In particular, FIG. 9 shows a plurality of curves, each curve corresponding to a different value of E as indicated, with T_{OBS} on the vertical axis and CL on the horizontal axis. It is clear that the implementation of the invention does not require the plotting of the curves, instead the equation can be solved numerically.

The curves in FIG. 9, or the numerical solution, can be used as follows. A value for CL can be fixed, which is deemed to ensure sufficient reliability, for instance, 0.9. This results, as visible in FIG. 9, in a vertical line intercepting—at T0, T1, T2, etc.—the curves corresponding to 0, 1 or 2, etc. detected errors E.

A similar set of curves can be plotted, or the equation can be solved, for
a degraded BER, that is, for the BER for which the channel is assumed to be degraded, for instance 10⁻⁵, and/or for
a nominal BER, that is, for the BER for which the channel is assumed to be working correctly, for instance 10⁻¹².

In this manner it is possible obtain the following times values
T0_{DEG} with the degraded BER value, and/or
T0_{NOM} with the nominal BER value, which will be higher than T0_{DEG}
T1_{DEG} with the degraded BER value, and/or
T1_{NOM} with the nominal BER value, which will be higher than T1_{DEG}
T2_{DEG} with the degraded BER value, and/or
T2_{NOM} with the nominal BER value, which will be higher than T2_{DEG}
etc.

for the values of E=0, E=1, E=2, et.

The first predetermined time T0, used at step S714, can be computed as a time for which the equation is solved for the number of measured errors equal to 0, namely T0_{DEG}. That is, if the error has been detected within T0_{DEG} it can be concluded that the BER is higher than the predetermined threshold value, and thus the channel is to be considered as degraded.

Similarly, after repeating steps S711 and S712, if at least a second error has been detected at step S713, it can be evaluated if the second error has occurred within a second predetermined time T1. If so, at step S715 is can be determined that the first data channel is degraded. It follows from the description above that the second predetermined time T1 can be computed as a time for which the equation is solved for the number of measured errors equal to 1.

It will be clear to those skilled in the art that the method 700 can be extended for any number of errors and the corresponding predetermined time. Moreover, the method 700 can be expanded to indicate not only if the channel is degraded, but also to indicate if the channel is working correctly.

In particular, if no errors are observed within T0_{NOM} then it can be concluded that the channel is operating correctly. In some embodiments, the method 700 can therefore be implemented by the following pseudo-code
1. IF at least one error is observed within T0_{DEG}, THEN the BER threshold is exceeded; STOP. ELSE go to step 2.
2. IF no errors are observed within T0_{NOM}, THEN the channel is working fine; STOP. ELSE go to step 3.
3. IF at least two errors are observed within T1_{DEG}, THEN the BER threshold is exceeded; STOP. ELSE go to step 4.
4. IF no errors are observed within T1_{NOM}, THEN the TRX is working fine; STOP. ELSE GO TO step 5.
5. etc.

A timeout can also be implemented to avoid this to proceed indefinitely be set. The inventors have found that a practical choice is setting Time_out=T1_{DEG}, that is, to stop at step 3 concluding that no failure or degradation has occurred.

The methodology given above therefore provides one particularly advantageous manner of determining if a channel is degraded, by making this decision dependent on the bit error rate and not only upon measuring an error.

It will be clear to those skilled in the art that the methodology given above is particularly advantageous at low BER values, since it does not require a high number of transmitted bits or, equivalently, a long measurement time. In particular, implementing the steps 2 and 4, based on absence of errors rather than their presence, allows a conclusion on the state of the channel to be reached in a short time, even in the absence of errors.

It will nevertheless be clear to those skilled in the art that alternative manners can be implemented in order to define if a channel is degraded or not. For instance, a threshold in the absolute number of error, or a ratio between errored and transmitted bits, can be defined such that when the total errors, or the ratio, are higher than the threshold, the channel is defined as degraded.

The example of FIG. 7C therefore allows the identification of a degraded channel. IT will be clear to those skilled in the art that applying the method of FIG. 7D to a plurality of data channels can also allow identification of a plurality of degraded channels.

For instance, as visible in FIG. 7E, another parity bit channel, namely error channel E m,3, can start experiencing a high BER. This, can be used to indicate that data bit channel D 3,3 is degraded. Still further, as visible in FIG. 7F, another parity bit channel, namely error channel E 2,1, can start experiencing a high BER. In this case, the fault can't be detected without ambiguity, as it might be present on D 2,3 but also on D 2,4. Nevertheless, some action is still possible, for instance sending test signals on one or more of the potentially degraded channels D 2,3, D2,4, shutting down one or more of the potentially degraded channels D 2,3, D2,4, etc.

It is further clear to those skilled in the art that the pseudo-code above can be used to implement a method which allows recognizing if channels are degraded, by implementing steps 1, 3, 5, etc. only. That is, by checking for the presence of errors on the basis of T0_{DEG}, T1_{DEG}, etc. it can be determined if the channel is degraded. Thus, as described, it is possible to implement methods for detecting degradation of a channel on the basis of the presence of errors within a time computed on the basis of the equation and the degraded BER value.

Similarly, the pseudo-code above can be used to implement a method which allows recognizing if channels are working correctly, by implementing steps 2, 4, 6, etc. only. That is, by checking for the absence of errors on the basis of T0_{NOM}, T1_{NOM}, etc. it can be determined if the channel is operating correctly. Thus, alternatively or in addition to as described, it is possible to implement methods for detecting lack of degradation of a channel on the basis of the absence of errors within a time computed on the basis of the equation and the nominal BER value.

It will be clear to those skilled in the art that determination that a channel is degraded, or determination that a channel is not degraded, are complementary and thus the same result can be obtained by any of the two embodiments. Thus, although embodiments have been described more in details for the case in which degradation of a channel is determined by the presence of one or more errors within a given time threshold computed on the basis of the degraded BER value, it will be clear to those skilled in the art that alternative embodiments can be implemented, in which correct functioning, or lack of degradation, of a channel is determined by the absence of errors within a given time threshold computed on the basis of the nominal BER value.

It is a matter of course that those embodiments can also be combined, as described by the pseudo-code above, although this is not necessary.

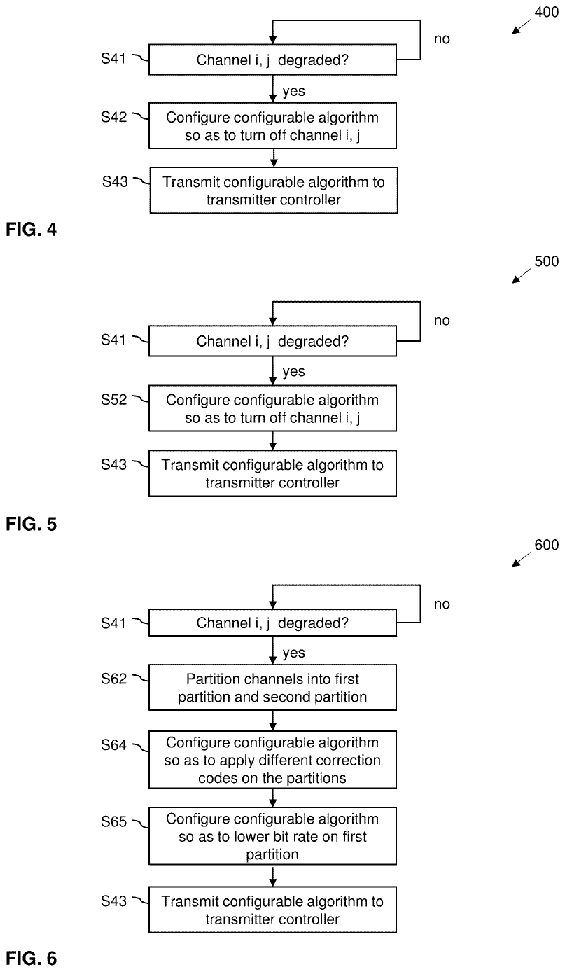

In the description above it has been generally indicated that the configurable algorithm can be configured to take into account a detection, at the receiver, that a given channel is degraded, or has errors. The skilled person will be aware that the configuration of the algorithm can take various forms, depending on the specific coding algorithm and the errors which are detected. In the following description examples will be presented for how exemplary algorithms can be configured in response to specific exemplary cases in which one or more channels are deemed to be degraded, with reference to the methods of FIGS. 4, 5, 6 and 8. It will however be clear that the invention is not necessarily limited to those examples.

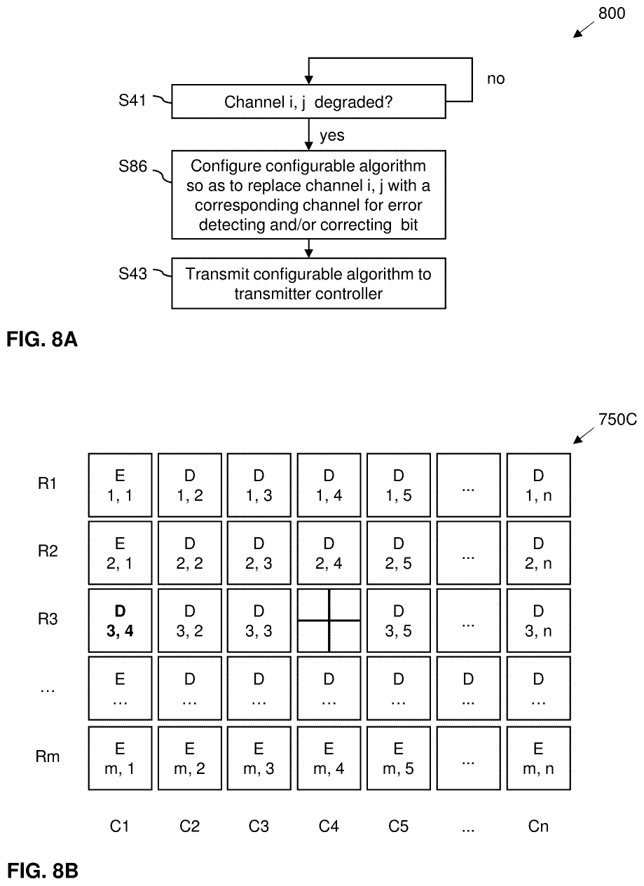

In particular, as visible in FIG. 8, at a step S41 the controller 121 can be configured to evaluate if the first data channel, for instance data channel D 3,4 in the example of FIG. 7B, is degraded based on the plurality of error detecting and/or correcting bits E, for instance as described in relation with method 700. At a step S86, if it is determined that the first data channel is degraded, the method 800 can comprise a step S86 to configure the configurable coding algorithm so as to substitute the first error channel, E 3,1 in the example of FIG. 7B, or the second error channel, E m,4 in the example of FIG. 7B, with the first data channel. The outcome of this exchange is schematically represented in FIG. 8B.

That is, according to method 800 of FIG. 8, the degraded channel for a data bit D can be remapped to a channel for an error bit E corresponding to the data bit D. This allows to maintain a constant transmission throughput even in the presence of a degraded channel.

Alternatively, or in addition, as visible in FIG. 4 after step S41, if it is determined that the first data channel is degraded, the controller can configure, at a step S42, the configurable coding algorithm so as to turn off the first data channel. This reduces the throughput of the transmission system, but it ensures that the transmission can continue without errors and the need to repeatedly evaluate and/or correct them, as well as requesting retransmissions, which are all operation which have a cost in terms of performances and throughput as well, so that simply turning off the degraded channel might lead to, all things considered, a more efficient transmission.

Still alternatively, or in addition, as visible in FIG. 5, after step S41, if it is determined that the first data channel is degraded, the controller can configure, at a step S52, the configurable coding algorithm so as to assign lower priority traffic the first data channel. In this manner, possible issues related to retransmission in case of errors can be better accepted, due to the lower priority nature of the traffic.

Still alternatively, or in addition, as visible in FIG. 6, after step S41, if it is determined that the first data channel is degraded, the controller can, at a step S62, partition the plurality of parallel channels 150 into a first partition, comprising the first data channel and a second partition, not comprising the first data channel. Moreover, the controller can, at a step S64, configure the configurable coding algorithm so as to implement different coding algorithms in the first and second partitions. For instance, in the first partition a coding algorithm with error correction capabilities higher than in the second partition could be implemented.

Still alternatively, or in addition, the method 500 can further comprise a step S65 to configure the configurable coding algorithm so as to implement a lower transmission bit rate in the first partition. This, in some embodiments, might be a direct result of implementing a step with higher error correction capabilities.

In any of methods 400, 500, 600, 800, which have been described with reference to operations carried out at the receiver 120, a further step S43 can be present to transmit the information on the reconfigured configurable algorithm to the transmitter 110. It will be clear to those skilled in the art that, if the methods are instead executed at the transmitter, step S43 can be used to transmit the information on the newly configured algorithm to the receiver.

FIG. 10 schematically illustrates steps of a method 1000, for parallel transmission of a first plurality of data bits D. Method 1000 can be advantageously executed by any of controllers 111 and 131, although the invention is not limited thereto.

As visible, the method 1000 comprises a step S101 of configuring a configurable coding algorithm. It will be clear to those skilled in the art that the step S101 can comprise any of the steps previously discussed for the configuration of the algorithm. The method 1000 further comprises a step S102 of coding the first plurality of data bits D into a second plurality of bits D+E according to the configurable coding algorithm. Any of the considerations previously made, and features previously described, for how the coding can be affected by the configurable coding algorithm, in particular with regards to the operation of the programmable encoder 112 and 212, also apply to step S102. Step S102 can be advantageously executed by the controller in combination with any of the previously described programmable encoders.

Finally, the method comprises a step S103 of optically transmitting the second plurality of bits D+E in parallel, over a plurality of parallel channels 150. Any of the considerations previously made, and features previously described, for how the transmission can be affected by the configurable coding algorithm, in particular with regards to the operation of the programmable parallel transmitter 113, also apply to step S103. Step S103 can be advantageously executed by the controller in combination with any of the previously described parallel transmitters.

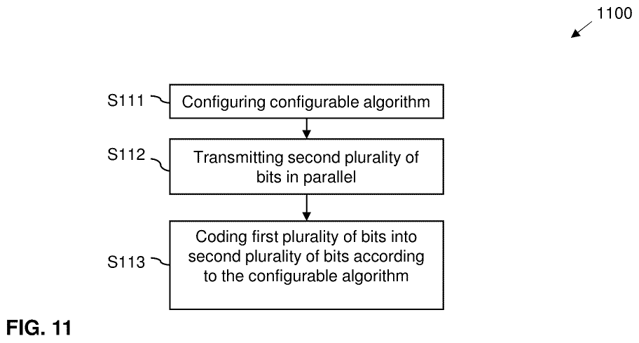

FIG. 11 schematically illustrates steps of method 1100 for receiving a plurality of data bits. Method 1100 can be advantageously executed by any of controllers 121 and 131, although the invention is not limited thereto.

As visible, the method 1100 comprises a step S111 of configuring a configurable coding algorithm. It will be clear to those skilled in the art that considerations made for step S101 also apply to step S111. The method 1100 further comprises a step S112 of optically receiving the second plurality of bits D+E in parallel, over a plurality of parallel channels 150. Any of the considerations previously made, and features previously described, for how the reception can be affected by the configurable coding algorithm, in particular with regards to the operation of the programmable parallel receiver 113, also apply to step S112. Step S112 can be advantageously executed by the controller in combination with any of the previously described parallel receivers.

Finally, the method comprises a step S113 of decoding the second plurality of bits D+E into a first plurality of data bits D according to the configurable coding algorithm. Any of the considerations previously made, and features previously described, for how the decoding can be affected by the configurable coding algorithm, in particular with regards to the operation of the programmable decoder 122 and 322, also apply to step S113. Step S113 can be advantageously executed by the controller in combination with any of the previously described programmable decoders

It will be clear to those skilled in the art that any of the previously described method steps can be added to, or integrated in, the methods 1000 and 1100. In particular, more specific embodiments discussed above which have been defined in terms of apparatus features can also be implemented in terms of methods, as will be clear to those skilled in the art.

It has thus been described how, in an system for optical transmission of parallel data, degradation on a channel can be detected and how this can lead to a reconfiguration of the coding algorithm used for the transmission, with particular reference to possible examples of such reconfiguration. It will be clear that this can find application in various telecommunication applications, with particular advantage in applications in which a large amount of data has to be transmitted. One particular advantageous application of the embodiments of the invention is therefore in a telecommunication network node, which might use the embodiments of the invention to transfer data to another telecommunication network node.

Although the invention has been described with reference to a number of devices, or apparatuses, in particular the various transmitters and receivers and their components, particularly including the various controllers, can be configured to execute one or more method steps. It will be clear to those skilled in the art that one or more of those method steps, and more in general one or more of any of the method steps described, can also be implemented by a generic CPU and a corresponding memory. In particular, embodiments of the invention can relate to a CPU and a memory, the memory containing instructions which, when executed by the CPU, cause the CPU to execute any of the various method steps described above, or any of the functions described in relation to the various devices, or apparatuses previously described. This is particularly advantageous, for instance, for the implementation of the one or more controllers as described, which could be implemented as a CPU a memory comprising instructions for any of the method steps previously described.

Although specific embodiments have been described, each with one or more features, the invention is not limited to the described embodiments. Further embodiments can in particular be obtained by combining any of the described features of any embodiment, even if not explicitly described.

### LIST OF REFERENCE NUMERALS

100: communication system
110: transmitter
111 controller
112: programmable encoder
113: parallel transmitter
120: receiver
121 controller
122: programmable encoder
123: parallel receiver
130: transceiver
131 controller
140: controlling channel
150: data channel
212: programmable encoder
2121: encoder
2122: switcher
322: programmable decoder
3221: decoder
3222: switcher
400: method for configuring coding algorithm
S41: evaluating if channel is degraded present
S42: configuring configurable coding algorithm
S43: communicating configurable algorithm to transmitter controller
500: method for configuring coding algorithm
S41: evaluating if error is present
S52: configuring configurable coding algorithm
600: method for configuring coding algorithm
S41: evaluating if error is present
S63: partition parallel channel
S64: use different coding algorithms on the partitions
S65: lower bit rate on first partition
700: method for configuring coding algorithm
S711: evaluate error at row
S712: evaluate error at column
S713: error determination
S714: evaluate if error within first predetermined time (T0)
S715: determine channel is degraded
S716: evaluate if two errors within second predetermined time (T1)
S717: determine channel is degraded
750A: logical mapping of parallel channels
750B: logical mapping of data and error correction/detection bits
750C: logical mapping comprising an error
800: method for configuring coding algorithm
S86: channel replacing step
1000: method for transmitting
S101: configuring configurable algorithm
S102: coding bits
S103: transmitting bits in parallel
1200: method for transmitting
S111: configuring configurable algorithm
S112: receiving bits in parallel
S113: decoding bits

1. A transmitter for parallel transmission of a first plurality of data bits (D), the transmitter comprising:
a programmable encoder for coding the first plurality of data bits (D) into a second plurality of bits (D+E), wherein the programmable encoder is configured to perform the coding according to a configurable coding algorithm;
parallel transmitter for transmitting the second plurality of bits (D+E) over a plurality of parallel channels, wherein the parallel transmitter is an optical emitting apparatus; and
a controller for configuring the configurable coding algorithm.

2. The transmitter according to claim 1, wherein
the parallel transmitter is implemented as a two-dimensional array.

3. The transmitter according to claim 1, wherein
the parallel transmitter is implemented as a plane and/or are configured to emit light substantially perpendicularly with respect to the plane.

4. The transmitter according to claim 1, wherein
the controller is configured to receive controlling data from a receiver, which can be connected to the transmitter, and
the controller is configured to configure the configurable coding algorithm based on the controlling data.

5. The transmitter according to claim 1, wherein
the second plurality of bits (D+E) comprises the first plurality of data bits (D) and a third plurality of error detecting and/or correcting bits (E), and
the programmable encoder is configured to generate the third plurality of error detecting and/or correcting bits (E) based on the first plurality of data bits (D) and the configurable coding algorithm.

6. The transmitter according to claim 1, wherein
the second plurality of bits (D+E) comprises the first plurality of data bits (D) and a third plurality of error detecting and/or correcting bits (E), and
the programmable encoder is configured to
associate the first plurality of data bits (D) to the second plurality of bits (D+E), and/or
associate the third plurality of error detecting and/or correcting bits (E) to the second plurality of bits (D+E),
based on the configurable coding algorithm.

7. The transmitter according to claim 1, wherein
the second plurality of bits (D+E) comprises the first plurality of data bits (D) and a third plurality of error detecting and/or correcting bits (E), and
the programmable encoder comprises switcher,
the switcher is configured to
associate the first plurality of data bits (D) to the second plurality of bits (D+E), and/or
associate the third plurality of error detecting and/or correcting bits (E) to the second plurality of bits (D+E),
based on the configurable coding algorithm.

8. The transmitter according to claim 7, wherein
the programmable encoder further comprises encoder, and
the encoder is configured to generate the third plurality of error detecting and/or correcting bits (E) based on the first plurality of data bits (D) and a first coding algorithm.

9. The transmitter according to claim 8, wherein
the first coding algorithm is the configurable coding algorithm.

10. A receiver for parallel reception of a second plurality of bits (D+E), the receiver comprising:
a programmable decoder for decoding the second plurality of bits (D+E) into a first plurality of data bits (D), wherein the programmable decoder is configured to perform the decoding according to a configurable coding algorithm;
parallel receiver for receiving the second plurality of bits (D+E) over a plurality of parallel channels, wherein the parallel receiver is an optical capturing apparatus; and
a controller for configuring the configurable coding algorithm.

11-18. (canceled)

19. The receiver according to claim 10, wherein
the second plurality of bits (D+E) comprises the first plurality of data bits (D) and a third plurality of error detecting and/or correcting bits (E),
the plurality of parallel channels comprises a plurality of logical rows (R1-Rm) and a plurality of logical columns (C1-Cn),
a first one of the first plurality of data bits (D) is mapped to a first data channel (D 3,4), the first channel corresponding to a first logical row (R3) and a first logical column (C4),
a first one of the third plurality of error detecting and/or correcting bits (E) is mapped to a first error channel (E 3,1), the first error channel (E 3,1) corresponding to the first logical row (R3), and
a second one of the third plurality of error detecting and/or correcting bits (E) is mapped to a second error channel (E m,4), the second error channel (E m,4) corresponding to the first logical column (C4).

20. The receiver according to claim 19, wherein the controller is configured to
evaluate if a first row error is detected at the first logical row (R3), if the first row error has been detected, evaluate if a first column error is detected at the first logical column (C4),
if the first column error is detected, determine that a first error has been detected at the first data channel (D 3,4),
if it is determined that the first error has been detected, evaluate if the first error has been detected within a first predetermined time (T0),
if the first error has been detected within the first predetermined time (T0), determine that the first data channel (D 3,4) is degraded.

21. The receiver (420) according to claim 20, wherein the controller is further configured to
evaluate if a second row error is detected at the first logical row (R3),
if the second row error has been detected, evaluate if a second column error is detected at the first logical column (C4),
if the second column error is detected, determine that a second error has been detected at the first data channel (D 3,4),
if it is determined that the second error has been detected, evaluate if the second error has been detected within a second predetermined time (T1),
if the second error has been detected within the second predetermined time (T1), determine that the first data channel (D 3,4) is degraded.

22-24. (canceled)

25. The receiver according to claim 19, wherein the controller is configured to
evaluate if the first data channel (D 3,4) is degraded based on the third plurality of error detecting and/or correcting bits (E), and
if it is determined that the first data channel (D 3,4) is degraded, configure the configurable coding algorithm so as to substitute the first error channel (E 3,1), or the second error channel (E m, 4), with the first data channel (D 3,4).

26. The receiver according to claim 10, wherein
the second plurality of bits (D+E) comprises the first plurality of data bits (D) and a third plurality of error detecting and/or correcting bits (E), and
the controller is configured to
evaluate if the first data channel (D 3,4) is degraded based on the third plurality of error detecting and/or correcting bits (E),
if it is determined that the first data channel (D 3,4) is degraded, configure the configurable coding algorithm so as to turn off the first data channel (D 3,4).

27. The receiver according to claim 10, wherein
the second plurality of bits (D+E) comprises the first plurality of data bits (D) and a third plurality of error detecting and/or correcting bits (E), and
the controller is configured to
evaluate if the first data channel (D 3,4) is degraded based on the third plurality of error detecting and/or correcting bits (E),
if it is determined that the first data channel (D 3,4) is degraded, configure the configurable coding algorithm so as to assign lower priority traffic the first data channel (D 3,4).

28-29. (canceled)

30. The receiver (12) according to claim 25, wherein
for evaluating if the first data channel (D 3,4) is degraded the controller is further configured to determine, based on the third plurality of error detecting and/or correcting bits (E), if the first data channel (D 3,4) experiences an error rate higher than a predetermined threshold.

31. The receiver (120) according to claim 30, wherein
the controller is further configured to determine, based on the third plurality of error detecting and/or correcting bits (E), if the first data channel (D 3,4) experiences the error rate higher than the predetermined threshold within a predetermined time.

32-34. (canceled)

35. A transmitting method for parallel transmission of a first plurality of data bits (D), the method comprising the steps of:
configuring a configurable coding algorithm;
coding the first plurality of data bits (D) into a second plurality of bits (D+E) according to the configurable coding algorithm; and
optically transmitting the second plurality of bits (D+E) in parallel, over a plurality of parallel channels.

36. A receiving method for parallel reception of a second plurality of bits (D+E), the method comprising the steps of:
configuring a configurable coding algorithm;
optically receiving the second plurality of bits (D+E) in parallel over a plurality of parallel channels; and
decoding the second plurality of bits (D+E) into a first plurality of data bits (D) according to the configurable coding algorithm.
